(19) United States
(12) Patent Application Publication
(10) Pub. No.: US 2013/0310494 A1
(43) Pub. Date: Nov. 21, 2013

(54) FLAME-RETARDANT THERMOPLASTIC COMPOSITION

(71) Applicants: Siqi Xue, Shanghai (CN); Michael Roth, Lautertal (DE); Elke Marten, Ostercappeln (DE); Martin Klatt, Mannheim (DE)

(72) Inventors: Siqi Xue, Shanghai (CN); Michael Roth, Lautertal (DE); Elke Marten, Ostercappeln (DE); Martin Klatt, Mannheim (DE)

(73) Assignee: BASF SE, Ludwigshafen (DE)

(21) Appl. No.: 13/980,080

(22) PCT Filed: Jan. 12, 2012
(86) PCT No.: PCT/EP12/50332

§ 371 Date: Jul. 17, 2013

(30) Foreign Application Priority Data
Jan. 17, 2011 (EP) 11151122.6

(51) Int. Cl. C08L 67/02; C09D 167/02

(52) U.S. Cl. CPC C08L 67/02; C09D 167/02
USPC 524/101; 524/133

(57) ABSTRACT

A thermoplastic composition comprising A) a polyalkylene terephthalate; B) an elastomer selected from b1) the polyalkylene terephthalate polyester urethanes, b2) the polyalkylene terephthalate polyether urethanes, b3) the polyalkylene terephthalate polyethers, b4) of the polyalkylene terephthalate polyesters, and mixtures of these; C) a halogen-free flame retardant selected from c1) the nitrogen-containing flame retardants, c2) the nitrogen- and phosphorus-containing flame retardants, c3) of the phosphorus-containing flame retardants, and mixtures of these. The use of the thermoplastic composition of the invention for producing fibers, foils, or moldings, and also to fibers, foils or moldings which comprise the composition of the invention. The use of the thermoplastic composition as coating compositions.

The invention relates to a thermoplastic composition comprising
A) a polyalkylene terephthalate
B) an elastomer selected from the group
   b1) of the polyalkylene terephthalate polyester urethanes,
   b2) of the polyalkylene terephthalate polyether urethanes,
   b3) of the polyalkylene terephthalate polyethers,
   b4) of the polyalkylene terephthalate polyesters,
   and mixtures of these,
C) a halogen-free flame retardant selected from the group
   c1) of the nitrogen-containing flame retardants,
   c2) of the nitrogen- and phosphorus-containing flame retardants,
   c3) of the phosphorus-containing flame retardants,
   and mixtures of these.

The invention further relates to the use of the thermoplastic composition of the invention for producing fibers, foils, or moldings, and also to fibers, foils or moldings which comprise the composition of the invention. The invention further relates to the use of the thermoplastic composition as coating composition.

Specifically, the invention relates to a thermoplastic composition comprising (A) a polybutylene terephthalate, (B) a polybutylene terephthalate polyester urethane (b1), (C) aluminum diethylphosphinate, melamine cyanurate, or melamine polyphosphate, or a mixture of these.

Another embodiment relates to a thermoplastic composition comprising (A) a polybutylene terephthalate, (B) a polybutylene terephthalate polyether (b2), (C) aluminum diethylphosphinate, melamine cyanurate, or melamine polyphosphate, or a mixture of these.

In particular, the invention also relates to a thermoplastic composition comprising (A) a polybutylene terephthalate, (B) a polybutylene terephthalate polyester (b3), (C) aluminum diethylphosphinate, melamine cyanurate, or melamine polyphosphate, or a mixture of these.

Other preferred embodiments can be derived from the claims and from the description. Combinations of preferred embodiments are within the scope of the present invention.

The requirement for flame-retardant thermoplastic compositions is of increasing interest, and in particular there is demand for compositions that are halogen-free, in particular chlorine- and bromine-free.

WO 2009/009249 A2 describes a halogen-free polyester composition with various flame-retardant and stabilizing additions. Conventional hard-segment polyesters are used here.

US 2008/0167406 A1 describes a flame-retardant molding composition based on polybutylene terephthalate and comprising a thermoplastic polyester elastomer alongside a phosphinic salt and an epoxy compound. Said elastomer can on the one hand be a polyester-polyester elastomer. The hard segment here can be a polyester made of an aromatic diacid and of a short-chain alkylenediol. The soft segment is composed of a polyester, of an aliphatic diacid, and of a short-chain alkylenediol or polycaprolactone. Said elastomer can on the other hand be a polyester-polyether elastomer, where the hard segment is a polyester composed of an aromatic diacid and of a short-chain alkylenediol and the soft segment is a polyoxyalkylene glycol or a polyester made of polyoxyalkylene units and of an aliphatic diacid.

WO 2006/040066 A1 describes a flame-retardant molding composition which comprises, alongside polybutylene terephthalate as main component, at least one highly branched or hyperbranched polycarbonate, and/or at least one highly branched polyester, or mixture of the two. Various flame-retardant additives are added to the molding composition.

It was an object of the present invention to develop a thermoplastic composition which has good processability and at the same time has a flame-retardant effect. A further intention was to provide compositions which have a pale intrinsic color. A further object was to find thermoplastic compositions with flame-retardant effect which are odor-neutral. The compositions were also intended to be suitable for producing coatings.

Said object is achieved with a thermoplastic composition described in the introduction.

Component A of the thermoplastic composition of the invention is a polyalkylene terephthalate. This expression also covers mixtures of polyalkylene terephthalates. For the purposes of the invention, polyalkylene terephthalate is not restricted to compounds comprising terephthalate: instead, polyalkylene terephthalates of the invention derive from structures which comprise, in the main chain, an aromatic ring which derives from an aromatic dicarboxylic acid. The aromatic ring can be an unsubstituted or substituted ring. Obvious substituents are inter alia C₁-C₄-alkyl groups, such as methyl, ethyl, isopropyl, n-propyl, n-butyl, isobutyl, or tert-butyl groups, or fluorine.

Preferred dicarboxylic acids are substituted dicarboxylic acids, in particular unsubstituted 2,6-naphthalenedicarboxylic acid, terephthalic acid, and isophthalic acid, and mixtures of these. Among these, preference is given to terephthalic acid or isophthalic acid or a mixture of these. Terephthalic acid is often used as sole monomeric dicarboxylic acid.

Polyalkylene terephthalates comprise, alongside aromatic moieties that derive from appropriate dicarboxylic acids, aliphatic hydrocarbon moieties that derive from the corresponding alkylenediols. The alkylenediols can be branched or unbranched, i.e. linear. Branched polyalkylene terephthalates comprise branched hydrocarbon moieties, while linear polyalkylene terephthalates comprise unbranched hydrocarbon moieties. The thermoplastic compositions of the invention preferably use linear polyalkylene terephthalates.

Among the alkylenediols, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol, or neopentyl glycol, or a mixture of these.

In one preferred embodiment of the invention, component A can comprise polyethylene terephthalate, polypropylene 1,3-terephthalate, polybutylene 1,4-terephthalate, polyethylene naphthalate, polybutylene 1,4-naphthalate, poly(cyclohexanedimethanol terephthalate), or a mixture of these.

The intrinsic viscosity of these polyalkylene terephthalates measured in phenol/carbon tetrachloride (ratio 1/1 by volume) is generally from 0.4 dL/g to 2.0 dL/g. The average molar mass of the polyalkylene terephthalates is generally from 5000 to 130 000 g/mol (determined by means of gel permeation chromatography in chloroform/hexafluoroisopropanol (ratio 5/95 by volume) at 25° C. and measured against a polystyrene standard).

The thermoplastic composition in the invention comprises an elastomer (component B) selected from the group of the polyalkylene terephthalate polyester urethanes b1), polyalkylene terephthalate polyether urethanes b2), polyalkylene terephthalate polyethers b3), polyalkylene terephthalate polyesters b4) and mixtures of these.

An elastomer is a copolymer in which hard segments and soft segments can be combined. Hard segments generally feature stiff elongate sections. Soft segments generally comprise distinctly tangled domains. Hard segments mostly associate with one another and form intermolecular bonds, and this increases the coherence between the polymer strands. Soft segments can be elongated, and therefore provide elasticity to the domain.

The elastomer b1) comprises polyalkylene terephthalates as hard segment and polyester urethane as soft segment (for formula, see WO03014179, pages 9-10).

The usual production process begins by reacting a polyalkylene terephthalate with one or more hydroxy compounds, and it is preferable here to use one or more low-molecular-weight diols which generally have a molar mass of from 62 g/mol to 500 g/mol (i), in order to form a polyalkylene terephthalate hydroxy compound. Said polyalkylene terephthalate hydroxy compound can then be reacted first with one or more polyesterols which generally have a molar mass of from above 500 to 8000 g/mol, preferably 700 to 6000 g/mol, in particular 800 to 4000 g/mol (ii), and then with a, or a mixture of different, isocyanates (iii).

The hard segment of the thermoplastic elastomer b1) can differ from the polyalkylene terephthalate A in structural composition and/or in distribution. However, the hard segment can also have the same structural composition as A. By way of example, the hard segment of the thermoplastic elastomer can be a polyalkylene terephthalate based on terephthalic acid and on an alkylenic diol having from 2 to 15 carbon atoms. It is preferably that the hard segment is a polybutylene terephthalate, in particular a polybutylene 1,4-terephthalate. The average molar mass of the polyalkylene terephthalate segment(s) is generally from 1000 to 5000 g/mol (determined by means of gel permeation chromatography in chloroform/hexafluoroisopropanol (ratio 5/95 by volume) at 25° C. and measured against a polystyrene standard).

In order to form the polyalkylene terephthalate hydroxy compound, the thermoplastic polyalkylene terephthalate can by way of example be reacted in step (i) with one or more diols, preferably with a well known low-molecular-weight diol, in particular with diols having a molar mass of from 62 to 500 g/mol, for example ethylene glycol, 1,3-propanediol, 1,4-butanediol, 1,5-pentanediol, 1,6-hexanediol, heptanediol, octanediol, preferably 1,4-butanediol and/or 1,2-ethanediol.

The ratio by weight of polyalkylene terephthalate to diol in step (i) is usually from 100:1 to 100:10, preferably from 100:1.5 to 100:8.0. The molar mass of the polyalkylene terephthalate hydroxy compound as reaction product from (i) is preferably from 1000 g/mol to 5000 g/mol.

The melting point of the polyalkylene terephthalate hydroxy compound as reaction product from (i) is preferably from 150° C. to 260° C., particularly preferably from 151° C. to 260° C., in particular from 165° C. to 245° C., and this therefore means that the polyalkylene terephthalate hydroxy compound of the thermoplastic polyalkylene terephthalate with the diol in step (i) comprises compounds with the melting point mentioned which are used in the following step (ii).

In step ii), the polyalkylene terephthalate hydroxy compound can be way of example be reacted with aliphatic polyesterols with molecular weights of from above 500 to 8000, preferably 700 to 6000, in particular 800 to 4000. The average functionality of the polyesterols is preferably from 1.8 to 2.6, preferably from 1.9 to 22, in particular 2. The term “functionality” in particular means the number of active hydrogen atoms, in particular hydroxy groups.

It is preferable to use polyesterols that are obtainable via reaction of butanediol and hexanediol as diol with adipic acid as dicarboxylic acid, where the ratio by weight of butanediol to hexanediol is preferably 2:1. Polytetrahydrofuran with a molar mass of from 750 to 2500 g/mol, preferably from 750 to 1200 g/mol, is moreover preferred as polyesterol.

By virtue of the reaction of the thermoplastic polyalkylene terephthalate with the diol in step (i) to give the polyalkylene terephthalate hydroxy compound and of the reaction that then follows with the polyesterol in step (ii), the intermediate product has free hydroxy groups which in the further step (iii) are further processed with isocyanate to give elastomer b1), the polyalkylene terephthalate polyester urethane.

Isocyanates used are generally conventional aliphatic, cycloaliphatic, araliphatic and/or aromatic isocyanates, preferably diisocyanates, for example tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanat, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, dicyclohexylmethane 4,4′-, 2,4′-, and/or 2,2′-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethyldiphenyl diisocyanate, 1,2-diphenylethane diisocyanate, and/or phenylene diisocyanate, preferably diphenylmethane 2,2′-, 2,4′-, and/or 4,4′-diisocyanate (MDI) and/or hexamethylene diisocyanate (HDI).

Examples of suitable polyalkylene terephthalate polyester urethanes b1) are randomly distributed copolymers with from 10% by weight to 35% by weight content of soft segment.

The polyalkylene terephthalate polyester urethane can be produced by processes known to the person skilled in the art, for example by a batch synthesis or reaction in an extruder. One possible synthesis of said thermoplastic elastomer b1) composed of a hard segment and of a soft segment has been described in WO 03 014 179 (page 7, line 32 to page 8, line 42, pages 13 to 18).

The elastomer b2) comprises polyalkylene terephthalates as hard segment and polyether urethane as soft segment. To this end, a polyalkylene terephthalate hydroxy compound as described above can be reacted with one or more polyetherols. These polyetherols generally have molar masses of from above 500 g/mol to 8000 g/mol, preferably 700 to 6000 g/mol, in particular 800 to 4000 g/mol. The preferred average functionality of the polyetherols is from 1.8 to 2.6, preferably from 1.9 to 22, in particular 2.

By virtue of the reaction of the thermoplastic polyalkylene terephthalate with the diol in step (i) to give the polyalkylene terephthalate hydroxy compound and of the reaction that then follows with the polyetherol in step (ii), the intermediate product has free hydroxy groups which in the further step (iii) are further processed with isocyanate to give actual product, the polyalkylene terephthalate polyether urethane. This reaction takes place as described for the production of the elastomers b1).

Examples of suitable polyalkylene terephthalate polyether urethanes b2) are randomly distributed copolymers with from 10% by weight to 35% by weight content of soft segment.

The polyalkylene terephthalate polyether urethane can be produced by processes known to the person skilled in the art, for example by a batch synthesis or reaction in an extruder.

In another embodiment of the invention, the thermoplastic composition comprises an elastomer b3) comprising a polyalkylene terephthalate polyether. Products of this type are known in the literature or are accessible by means of methods known per se. By way of example, polyester polyethers are described in the following US specifications: U.S. Pat. Nos. 3,651,014, 3,784,520, 4,185,003, and 4,136,090.

The hard segment of the elastomer b3) can differ from the polyalkylene terephthalate A in structural composition and/or in distribution. However, the hard segment can also have the same structural composition as A. By way of example, the hard segment of the thermoplastic elastomer can be a polyester based on terephthalic acid and on an alkylenic diol having from 2 to 15 carbon atoms. It is preferable that the hard segment is a polybutylene terephthalate.

The soft polyether segment of the thermoplastic elastomer (b2) in the invention can be a polyester polyether. In this invention, the expression polyester polyethers means compounds deriving from poly(alkylene) ether glycols and from short-chain low-molecular-weight diols and dicarboxylic acids.

A possible structure formula is revealed in lines 1-15 on page 29 of the specification WO2007/009930. It is of course also possible to use mixtures of a plurality of poly(alkylene oxide) glycols, of a plurality of diols, and/or a plurality of dicarboxylic acids.

The melting point of the poly(alkylene oxide) glycols is preferably below 55° C. and they preferably have a carbon/oxygen ratio of from 2 to 10, in particular from 2 to 6. Examples of poly(alkylene oxide) glycols are poly(ethylene oxide) glycol, poly(1,2-propylene oxide) glycol, poly(propylenene 1,3-oxide) glycol, poly(butylene 1,2-oxide) glycol, poly(butylene 1,3-oxide) glycol, poly(butylene 1,4-oxide) glycol, poly(pentamethylene oxide) glycol, poly(hexamethylene oxide) glycol, poly(heptamethylene oxide) glycol, poly(octamethylene oxide) glycol, poly(nonamethylene oxide) glycol, and also random or block copolymers of various glycols from those mentioned above. Preference is given to use of poly(ethylene oxide) glycol, poly(propylene 1,2-oxide) glycol, poly(propylene 1,3-oxide) glycol, and poly(butylene 1,4-oxide) glycol, and also of mixtures of these. The molar mass of the long-chain poly(alkylene oxide) glycol can preferably be from 400 to 3000 g/mol. The molar mass can be determined from the OH number. For this, the OH number can be established by means of titration. The molar mass Mw can thus be determined by using the formula Mw≈56.1×functionality×1000/OH number in mg KOH/g. (Carey, M.; Wellons, S.; Elder, D. Journal of Cellular Plastics 1984, 20, 42.)

Diols that can be used are very generally low-molecular-weight diols with molecular weights that are preferably below 250. The parent structure of these can be linear or branched, cycloaliphatic, or aromatic.

Particular preference is given to diols having from 2 to 15 carbon atoms. Examples that may be mentioned here are 1,2-ethanediol, 1,3-propanediol, 1,2-propanediol, 1,4-butanediol, 1,3-butanediol, 1,2-butanediol, 1,5-pentanediol, 2,2-dimethyl-1,3-propanediol, 1,6-hexanediol, and also its isomers. Among these, particular preference is given to aliphatic diols having from 2 to 8, in particular from 2 to 4, carbon atoms, in particular 1,3-propanediol and/or 1,4-butanediol. Unsaturated diols have also proven to be suitable in particular in mixtures with above-mentioned diols. 2-Butene-1,4-diol may in particular be highlighted here.

Dicarboxylic acids used are preferably compounds with molecular weights below 300. The dicarboxylic acids can be aromatic, aliphatic, or cycloaliphatic compounds, and can have substituents which do not cause disruption during the course of the polymerization. The dicarboxylic acids can also be aromatic compounds, and can have substituents, as long as the resultant polymer can be a soft segment.

Examples that may be mentioned of aromatic dicarboxylic acids are terephthalic acid, isophthalic acid, and derivatives thereof. Aliphatic dicarboxylic acids that can be used are oxalic acid, fumaric acid, maleic acid, citroconic acid, sebacic acid, adipic acid, glutaric acid, succinic acid, azelaic acid, and the like. It is also possible to use mixtures of various aliphatic dicarboxylic acids. It is also possible to use, instead of the acids, ester-forming derivatives of these. Preference is given to aromatic dicarboxylic acids. A possible synthesis of the thermoplastic elastomer (b2) is described in U.S. Pat. No. 3,651,014.

Various block copolymers are suitable as polyalkylene terephthalate polyether b3).

In another embodiment of the invention, the thermoplastic composition comprises an elastomer b4) which can be a polyalkylene terephthalate polyester.

b4) can therefore be a copolymer comprising a mixture of an aromatic diacid and of an aliphatic diacid, where a diol is added to the mixture.

The aromatic diacids can be 2,6-naphthalenedicarboxylic acid, terephthalic acid, and isophthalic acid, or a mixture of these.

The aliphatic diacids can be oxalic acid, fumaric acid, maleic acid, citroconic acid, sebacic acid, adipic acid, succinic acid, glutaric acid, and azelaic acid, or a mixture of these.

The diols can be C2-C15-diols, for example 1,2-ethanediol, 1,3-propanediol, 1,2-propanediol, 1,4-butanediol, 1,3-butanediol, 1,2-butanediol, 1,5-pentanediol, 2,2-dimethyl-1,3-propanediol, 1,6-hexanediol, and isomers of these.

The molar ratio of aromatic diacid to aliphatic diacid can vary widely, from 9/1 to 1/9.

The polyalkylene terephthalate polyester can be produced by processes known to the person skilled in the art, for example by a batch synthesis or reaction in an extruder.

The thermoplastic composition of the invention also comprises a halogen-free flame retardant (C) selected from the group of the nitrogen-containing or phosphorus-containing flame retardants or of the P- and N-containing flame retardants, and mixtures of these.

The term “halogen-free” in this connection is to be interpreted in accordance with the definitions provided by the “International Electronical Commission” (IEC 61249-2-21) and by the “Japan Printed Circuit Association” (JPCA-ES-01-1999), which define halogen-free materials as those that are very substantially chlorine- and bromine-free.

The thermoplastic composition can comprise, from the group of the nitrogen-containing flame retardants (c1), a halogen-free compound from the group of nitrogen-containing heterocycles having at least one nitrogen atom. The thermoplastic composition can also comprise mixtures of the nitrogen-containing heterocycles having at least one nitrogen atom.

Among the flame retardants that are preferably suitable in the invention is melamine cyanurate. Melamine cyanurate is a reaction product of preferably equimolar amounts of melamine (formula I) and cyanuric acid or isocyanuric acid (formulae Ia and Ib)

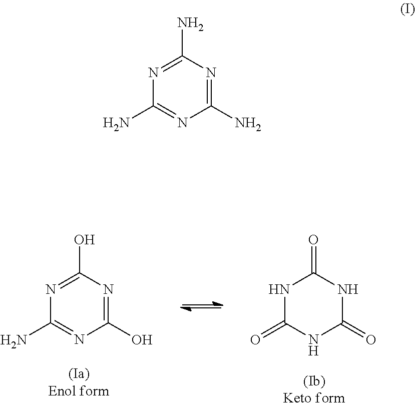 [SMILES: Nc1nc(N)nc(N)n1 ; Nc1nc(O)nc(O)n1 ; O=c1[nH]c(=O)[nH]c(=O)[nH]1]

Melamine cyanurate can be obtained by way of example via reaction of aqueous solutions of the starting compounds at from 90 to 100° C.

Other suitable compounds (often also termed salts or adducts) are melamine, melamine borate, and melamine oxalate. Mixtures of said salts can also be used.

From the group of the flame retardants (C), the thermoplastic composition in the invention can also comprise a halogen-free compound from the group of the P- and N-containing flame retardants (c2). Examples of suitable P- and N-containing flame retardants are described in WO 2002/96976.

Suitable compounds here are melamine phosphate (prim.), melamine phosphate (sec)., and melamine pyrophosphate (sec.), melamine neopentyl glycol borate, and also polymeric melamine phosphate (CAS No. 56386-64-2).

Suitable guanidine salts are

| | CAS No. |
|---|---|
| G carbonate | 593-85-1 |
| G cyanurate (prim.) | 70285-19-7 |
| G phosphate (prim.) | 5423-22-3 |
| G phosphate (sec.) | 5423-23-4 |
| G sulfate (prim.) | 646-34-4 |
| G sulfate (sec.) | 594-14-9 |
| Guanidine pentaerythritol borate | N.A. |
| Guanidine neopentyl glycol borate | N.A. |
| Urea phosphate green | 4861-19-2 |
| Urea cyanurate | 57517-11-0 |
| Ammeline | 645-92-1 |
| Ammelide | 645-93-2 |
| Melem | 1502-47-2 |
| Melon | 32518-77-7 |

For the purposes of the present invention the compounds include, for example, benzoguanamine itself and its adducts or salts, and also the derivatives substituted on nitrogen and their adducts or salts.

Another suitable compound is ammonium polyphosphate (NH₄PO₃)ₙ, where n is approximately from 200 to 1000, preferably from 600 to 800, and tris(hydroxyethyl) isocyanurate (THEIC) of the formula II

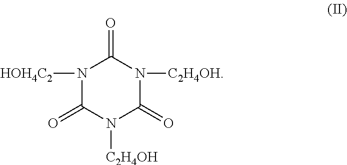

Other suitable compounds are benzoguanamine compounds of the formula III

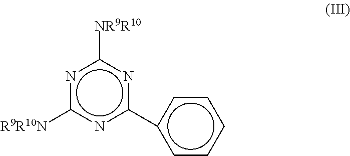

where R⁹ and R¹⁹ are straight-chain or branched alkyl moieties having from 1 to 10 carbon atoms, preferably hydrogen, and in particular their adducts with phosphoric acid, boric acid, and/or pyrophosphoric acid.

Preference is further given to allantoin compounds of the formula IV

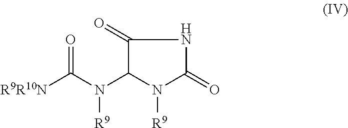

where R⁹ and R¹⁰ are defined as stated in formula III, and also to salts of these with phosphoric acid, boric acid and/or pyrophosphoric acid, and also to glycolurils of the formula V and their salts with the abovementioned acids

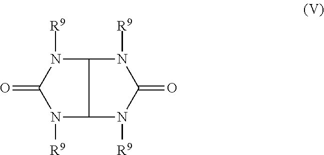

where R⁹ is defined as stated in formula III.

Suitable products are available commercially or, for example, in accordance with DE-A 196 14 424.

The cyanoguanidine (formula VI) that can be used in the invention is obtained by way of example via reaction of calcium cyanamide with carbonic acid, where the resultant cyanamide dimerizes at pH from 9 to 10 to give cyanoguanidine.

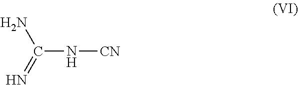

Preferred phosphorus-containing compounds (c3) are phosphinic salts of the formula (VII) and/or diphosphinic salts of the formula (VIII), and/or their polymers.

Just a few examples may be mentioned from the larger number of phosphorus-containing compounds suitable in the invention.

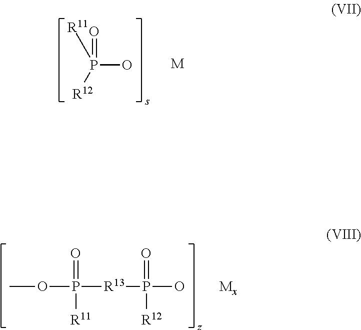

where the definitions of the substituents are as follows:
R¹¹ and R¹² are hydrogen, C1-C6-alkyl, preferably C₁-C₄-alkyl, linear or branched, e.g. methyl, ethyl, n-propyl, isopropyl, n-butyl, tert-butyl, n-pentyl; phenyl; where preferably at least one moiety R¹¹ or R¹² is hydrogen and in particular R¹¹ and R¹² are hydrogen;
R¹³ is C₁-C₁₀-alkylene, linear or branched, e.g. methylene, ethylene, n-propylene, isopropylene, n-butylene, tert-butylene, n-pentylene, n-octylene, n-dodecylene; arylene, e.g. phenylene, naphthylene;
   alkylarylene, e.g. methylphenylene, ethylphenylene, tert-butylphenylene, methylnaphthylene, ethylnaphthylene, tert-butylnaphthylene;
   arylalkylene, e.g. phenylmethylene, phenylethylene, phenylpropylene, phenylbutylene;
M is an alkaline earth metal or alkali metal, Al, Zn, Fe, Mg, Ca;
s is an integer from 1 to 3;
z is an integer from 1 to 3, and
x is 1 or 2.

Particular preference is given to compounds of the formula VII in which R¹¹ and R¹² are hydrogen, methyl, ethyl, or isobutyl, where M is preferably Ca, Zn, Mg, or Al, and very particular preference is given to aluminum diethylphosphinate and aluminum hypophosphites.

Phosphorus of the valence state +0 is elemental phosphorus. Red and black phosphorus can be used. Red phosphorus is preferred.

Phosphorus compounds of the oxidation state +5 which can be used are particularly alkyl- and aryl-substituted phosphates. Examples are phenyl bisdodecyl phosphate, phenyl ethyl hydrogenphosphate, phenyl bis(3,5,5-trimethylhexyl)phosphate, ethyl diphenyl phosphate, 2-ethylhexyl ditolyl phosphate, diphenyl hydrogenphosphate, bis(2-ethylhexyl) p-tolyl phosphate, tritolyl phosphate, bis(2-ethylhexyl) phenyl phosphate, dinonyl phenyl phosphate, phenyl methyl hydrogenphosphate, didodecyl p-tolyl phosphate, p-tolylbis(2,5,5-trimethylhexyl)phosphate and 2-ethylhexyl diphenyl phosphate. Particularly suitable phosphorus compounds are those in which each moiety is an aryloxy moiety. Very particularly suitable compounds are triphenyl phosphate and/or resorcinol bis(diphenyl phosphate) and/or its ring-substituted derivatives of the general formula X (RDP):

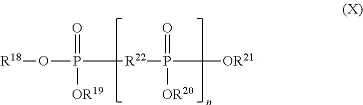

where the definitions of the substituents are as follows:
R¹⁸-R²¹ are an aromatic moiety having from 6 to 20 carbon atoms, preferably a phenyl moiety, which can have substitution by alkyl groups having from 1 to 4 carbon atoms, preferably methyl,
R²² is a divalent phenol moiety, preferably

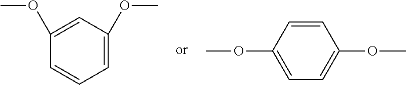

and the average value of n is from 0.1 to 100, preferably from 0.5 to 50, in particular from 0.8 to 10, and very particularly from 1 to 5.

Due to the process used for their manufacture, RDP products currently available commercially are mixtures of about 85% of RDP (n=1) with about 2.5% of triphenyl phosphate, and also about 12.5% of oligomeric fractions in which the degree of oligomerization is mostly smaller than 10.

The thermoplastic composition in the invention can comprise a fibrous, spheroidal, and/or lamellar reinforcing addition (D). Said reinforcing addition can by way of example be glass fibers, carbon fibers, aramid fibers, potassium titanate fibers, glass beads, amorphous silica, calcium silicate, magnesium carbonate, kaolins, chalk, powdered quartz, mica, barium sulfate, feldspar, metal hydroxides, metal oxides, similar mineral fillers, or a ceramic. Mixtures of the reinforcing additions are also possible.

The thermoplastic composition of the invention can moreover comprise at least one additional material, selected from the group of stabilizers, antistatic agents, nucleating agents, processing aids, impact modifiers, lubricants and mold-release aids, pigments, and antioxidants.

Examples of UV stabilizers that can be used are substituted resorcinols, salicylates, benzotriazoles, and benzophenones.

Examples of suitable inorganic pigments are titanium dioxide, ultramarine blue, and/or carbon black, while examples of organic pigments that can be admixed are perylenes, phthalocyanines and/or chinacridones. Other suitable materials are dyes, such as nigrosin, and/or anthraquinones for dying the thermoplastic composition.

Lubricants and mold-release agents that can be used are long-chain fatty acids (e.g. stearic acid) or salts thereof (e.g. Ca stearate). Proportions by weight used of lubricants and mold-release agents are mostly up to 1%, based on the entirety of the thermoplastic composition. Particular plasticizers that can be used are dioctyl phthalate, dibenzyl phthalate, butyl benzyl phthalate, hydrocarbon oils, and/or N-(n-butyl)benzenesulfonamide.

The thermoplastic composition of the invention can comprise fluorine-containing ethylene polymers. This preferably involves polymers of ethylene having from 55 to 76% by weight fluorine content. Examples here are polytetrafluoroethylene (PTFE), tetrafluoroethylene-hexafluoropropylene copolymers, and tetrafluoroethylene copolymers having relatively small proportions of copolymerizable ethylenically unsaturated monomers. These are described by way of example by Schildknecht in “Vinyl and Related Polymers”, Wiley-Verlag, 1952, pp. 484 to 494.

Said addition can be added to the thermoplastic composition either by way of admixture to one component or else in the form of separate admixture to the entire thermoplastic composition. It is preferable that the composition of the invention comprises no fluorine-containing ethylene polymers.

To the extent that the composition of the invention comprises one or more additional materials, the proportion of these is mostly not more than 5% by weight, based on the entirety of the thermoplastic composition. The proportion of additional materials is mostly at least 0.1% by weight, based on the entirety of the thermoplastic composition.

Components (A), (B), (C), and (D) can be mixed in various proportions by weight. The data below relating to the percentages by weight are based on the entirety of the thermoplastic composition. Addition of the individual percentages by weight in a thermoplastic composition gives 100% by weight.

Compositions of the invention comprise by way of example from 30 to 70% by weight of component (A), based on the entirety. The proportions by weight of (A) that can be used are preferably from to 40 to 60% by weight, in particular from 40 to 55% by weight, based on the entirety of the thermoplastic composition.

Amounts that can be used of the thermoplastic elastomer (B) are from 1 to 50% by weight. Amounts that can preferably be used of the thermoplastic elastomer are from 1 to 30% by weight, in particular from 3 to 15% by weight, based on the entirety of the thermoplastic composition.

It is possible to add proportions by weight of from 5 to 35% by weight, based on the entirety of the thermoplastic composition, of a halogen-free flame retardant (C), selected from the group c1) of the nitrogen-containing flame retardants, c2) of the nitrogen- and phosphorus-containing flame retardants, or c3) of the phosphorus-containing flame retardants, and mixtures of these. It is preferable to add proportions by weight of from 5 to 30% by weight, in particular from 5 to 25% by weight, of the flame retardant.

To the extent that the material comprises the reinforcing addition (D), proportions by weight that can be used thereof are from 1 to 50% by weight, based on the entirety of the thermoplastic composition. In one preferred embodiment, the thermoplastic composition comprises proportions by weight of from 15 to 60% by weight, in particular from 15 to 30% by weight, of a reinforcing addition, based on the entirety of the thermoplastic composition.

The following compositions are among the preferred thermoplastic compositions of the invention.

| Thermoplastic | Component A | Component B | Component C | Component D |
|---|---|---|---|---|
| composition^{a} | [% by wt.] | [% by wt.] | [% by wt.] | [% by wt.] |
| 1 | 40-55% | b1: 3-15 | c1: 5-25% | 15-30% |
| 2 | 40-55% | b1: 3-15 | c2: 5-25% | 15-30% |
| 3 | 40-55% | b1: 3-15 | c3: 5-25% | 15-30% |
| 4 | 40-55% | b2: 3-15 | c1: 5-25% | 15-30% |
| 5 | 40-55% | b2: 3-15 | c2: 5-25% | 15-30% |
| 6 | 40-55% | b2: 3-15 | c3: 5-25% | 15-30% |
| 7 | 40-55% | b3: 3-15 | c1: 5-25% | 15-30% |
| 8 | 40-55% | b3: 3-15 | c2: 5-25% | 15-30% |
| 9 | 40-55% | b3: 3-15 | c3: 5-25% | 15-30% |
| 10 | 40-55% | b4: 3-15 | c1: 5-25% | 15-30% |
| 11 | 40-55% | b4: 3-15 | c2: 5-25% | 15-30% |
| 12 | 40-55% | b4: 3-15 | c3: 5-25% | 15-30% |

^{a}Addition of the individual percentages by weight in a thermoplastic composition gives 100% by weight. Each thermoplastic composition can also comprise additional materials.

The thermoplastic composition of the invention can be produced by the known processes. To this end, the starting components are by way of example mixed in conventional mixing apparatuses, such as screw-based extruders, Brabender mixers, or Banbury mixers, and are then extruded, the extrudate can be cooled and comminuted. It is also possible to premix individual components and then to add the remaining starting materials in individual and/or likewise mixed form to the mixture. The mixing temperatures are generally within ranges from 240° C. to 265° C. The temperature is based on the temperature of the extruder.

The mechanical properties of the thermoplastic composition of the invention favor the use of the thermoplastic composition for the production of fibers, foils, and/or moldings. The thermoplastic composition is particularly suitable for the production of specific moldings in the construction of vehicles and of equipment, for example for industrial or consumer-related purposes. The thermoplastic composition can therefore be used for the production of electronic components, housings, housing components, protective cover flaps, bumpers, spoilers, bodywork components, damping elements, springs, handles, charge-air pipes, motor-vehicle-interior applications, such as instrument panels, components of instrument panels, instrument-panel supports, protective covers, air ducts, air-inlet grilles, sunroof rails, roof frames, add-on components, and in particular the center console, as part of the glovebox, or else tachometer covers.

The thermoplastic composition of the invention can be used as coating composition for fibers, foils, and/or moldings. The term moldings means articles which are three-dimensional solids and which are readily available for coating with a thermoplastic composition. The thickness of these coatings is generally within ranges from 0.1 to 3.0 cm, preferably from 0.1 to 2.0 cm, very particularly preferably from 0.5 to 2.0 cm. Coatings of this type can be produced by processes known to the person skilled in the art.

The thermoplastic composition of the invention can be used in processes for the production of industrially produced flame-retardant materials.

The thermoplastic composition of the invention exhibits a flame-retardant effect which complies with the most stringent requirements. In order to demonstrate the flame-retardant properties, moldings were produced, and surprisingly, in view of the good processability, these passed the UL 94 fire test with classification V-0 or V-2.

The thermoplastic composition has a surprisingly advantageous melt flow index, and also high resistance to breakage and impact.

Materials used:

### Component A:

PBT 1: Poly(butylene terephthalate) with intrinsic viscosity 130 mL/g (measurement made on a 0.5% by weight solution in a phenol/o-dichlorobenzene (1/1) mixture at 23° C.), Ultradur® B4520 from BASF SE.

PBT 2: Poly(butylene terephthalate), with intrinsic viscosity 107 mL/g (measurement made on a 0.5% by weight solution in a phenol/o-dichlorobenzene (1/1) mixture at 23° C.), Ultradur® B2550 from BASF SE.

### Component B:

Component b1)

Polyalkylene terephthalate polyester urethane 1-3: comprising poly(butylene terephthalate), adipate ester, hexamethylene diisocyanate, and butanediol; for hardness and melt index (melt flow index (MFI)) see table.

Polyalkylene terephthalate polyester urethane 1

PBT: 60%

Polyol: 25% of polyester made of adipic acid, butanediol, and 2-methylpropanediol (1+1),

Mn=3000 g/mol; OH number: 38 mg KOH/g

Isocyanate: 9% of hexamethylene diisocyanate 1,4-butanediol: 3.6%

Additives (finely powdered talc, sterically hindered phenol as antioxidant, carbodiimide as hydrolysis stabilizer, lubricant additive, antiblocking agent): 3.4%

Polyalkylene terephthalate polyester urethane 2

PBT: 67.5%

Polyol: 16% of polyester of adipic acid, butanediol+2-methylpropanediol (1+1),

Mn=3000 g/mol; OH number: 38 mg KOH/g

Isocyanate: 9% of hexamethylene diisocyanate

1,4-butanediol: 4.1%

Additives (finely powdered talc, sterically hindered phenol as antioxidant, carbodiimide as hydrolysis stabilizer, lubricant additive, antiblocking agent): 3.4%

Polyalkylene terephthalate polyester urethane 3

PBT: 71%

Polyol: 12.6% of polyester of adipic acid, butanediol+2-methylpropanediol (1+1),

Mn=3000 g/mol; OH number: 38 mg KOH/g

Isocyanate: 9% of hexamethylene diisocyanate

1,4-butanediol: 4.3%

Additives (finely powdered talc, sterically hindered phenol as antioxidant, carbodiimide as hydrolysis stabilizer, lubricant additive, antiblocking agent): 3.1%

Component b3)

Polyalkylene terephthalate polyether 1 and 2: comprising poly(butylene terephthalate) and poly(tetrahydrofuran); Hytrel® 7246 and Hytrel® 8238, from DuPont, for hardness and melt index (melt flow index (MFI)) see table.

Component b4)

Polyalkylene terephthalate polyester: comprising poly(butylene terephthalate) and poly(butylene adipate); Ecoflex® FBX 7011 from BASF SE, for hardness and melt index see table.

| | | Melt index (MFI) | | |
|---|---|---|---|---|
| | Shore D | at 230° C., | at 240° C., | at 190° C., |
| Component B | hardness | 2.16 kg | 2.16 kg | 2.16 kg |
| b1) Polyalkylene | 55 | 24 g/10 min | — | — |
| terephthalate | | | | |
| polyester | | | | |
| urethane 1 | | | | |
| b1) Polyalkylene | 64 | 38 g/10 min | — | — |
| terephthalate | | | | |
| polyester | | | | |
| urethane 2 | | | | |
| b1) Polyalkylene | 66 | 30 g/10 min | — | — |
| terephthalate | | | | |
| polyester | | | | |
| urethane 3 | | | | |
| b3) Polyalkylene | 72 | — | 12.5 g/10 min | — |
| terephthalate | | | | |
| polyether 1 | | | | |
| b3) Polyalkylene | 82 | — | 12.5 g/10 min | — |
| terephthalate | | | | |
| polyether 2 | | | | |
| b4) Polyalkylene | 32 | — | — | 5 g/10 min |
| terephthalate | | | | |
| polyester | | | | |

### Component C:

DEPAL: Aluminum diethylphosphinate.

MC: Melamine cyanurate, Melapur® MC 25 from BASF SE.

MPP: Melamine polyphosphate, Melapur® 200 from BASF SE.

### Component D:

Glass fibers: PPG 3786 glass fibers

### Other Additional Materials:

Stabilizer: The stabilizer comprises various antioxidants: primary phenolic antioxidants and secondary antioxidants, such as phosphites and thiosynergists): Irganox 1010 from BASF SE.

Lubricant: Oxidized polyethylene wax, Luwax® OA5 from BASF SE.

Production, processing, and testing of the thermoplastic composition:

Each of the mixtures was mixed at 260° C. in a twin-screw extruder and then injection-molded in accordance with ISO 294 (Title: Plastics—Injection moulding of test specimens of thermoplastic materials).

Melt volume flow rate (MVR) was measured at 275° C. with a weight of 2.16 kg.

The tensile strength test and the notched impact test were carried out in accordance with ISO 527 (Title: Determination of tensile properties) and in accordance with ISO 179 (Title: Determination of Charpy impact properties).

The UL 94 test for combustibility of plastics was carried out with 5 specimens of thickness 0.8 mm or 1.6 mm.

The injection-molding pressure is based on the pressure needed for the production of the specimens of thickness 0.8 mm for the UL 94 test for combustibility of plastics.

Examples: Polyalkylene terephthalate polyester urethane+DEPAL+MC

| | Comp. | Inv. | Inv. | Inv. | Inv. |
|---|---|---|---|---|---|
| | ex. | ex. 1 | ex. 2 | ex. 3 | ex. 4 |
| Component | | | | | |
| PBT 1 [%] | 52.4 | 47.4 | 47.4 | 47.4 | 42.4 |
| DEPAL [%] | 15 | 15 | 15 | 15 | 15 |
| MC [%] | 7.5 | 7.5 | 7.5 | 7.5 | 7.5 |
| Polyalkylene | — | 5 | — | — | — |
| terephthalate | | | | | |
| polyester | | | | | |
| urethane 1 [%] | | | | | |
| Polyalkylene | — | — | 5 | — | — |
| terephthalate | | | | | |
| polyester | | | | | |
| urethane 2 [%] | | | | | |
| Polyalkylene | — | — | — | 5 | 10 |
| terephthalate | | | | | |
| polyester | | | | | |
| urethane 3 [%] | | | | | |
| Stabilizer [%] | 0.1 | 0.1 | 0.1 | 0.1 | 0.1 |
| GF [%] | 25 | 25 | 25 | 25 | 25 |
| Properties | | | | | |
| UL 94 1.6 mm | V-0 | V-0 | V-0 | V-0 | V-0 |
| UL 94 0.8 mm | V-2 | V-2 | V-0 | V-2 | V-2 |
| MVR | 20 | 74 | 30 | 27 | 34 |
| (cc/10 min) | | | | | |
| Tensile strength | 96 | 96 | 98 | 101 | 101 |
| [MPa] | | | | | |
| Tensile modulus | 10.0 | 9.3 | 9.6 | 9.8 | 9.3 |
| [GPa] | | | | | |
| Charpy impact | 39.7 | 40.5 | 45.6 | 44.1 | 42.4 |
| resistance | | | | | |
| [kJ/m²] | | | | | |

Examples: Polyalkylene terephthalate polyester urethane+DEPAL+MC+MPP

| | | | | | | | | Inv. ex. |
|---|---|---|---|---|---|---|---|---|
| | Comp. ex. | Inv. ex. 5 | Inv. ex. 6 | Inv. ex. 7 | Inv. ex. 8 | Comp. ex. c | Inv. ex. 9 | 10 |
| Component | | | | | | | | |
| PBT 1 [%] | 52.4 | 47.4 | 47.4 | 47.4 | 42.4 | | — | — |
| PBT 2 [%] | — | — | — | — | — | 52.2 | 47.2 | 42.2 |
| DEPAL [%] | 15 | 15 | 15 | 15 | 15 | 15 | 15 | 15 |
| MC [%] | 3.75 | 3.75 | 3.75 | 3.75 | 3.75 | 3.75 | 3.75 | 3.75 |
| MPP [%] | 3.75 | 3.75 | 3.75 | 3.75 | 3.75 | 3.75 | 3.75 | 3.75 |
| Polyalkylene | — | 5 | — | — | — | — | — | — |
| terephthalate | | | | | | | | |
| polyester | | | | | | | | |
| urethane 1 [%] | | | | | | | | |
| Polyalkylene | — | — | 5 | — | — | — | 5 | 10 |
| terephthalate | | | | | | | | |
| polyester | | | | | | | | |
| urethane 2 [%] | | | | | | | | |
| Polyalkylene | — | — | — | 5 | 10 | — | — | — |
| terephthalate | | | | | | | | |
| polyester | | | | | | | | |
| urethane 3 [%] | | | | | | | | |
| Stabilizer [%] | 0.1 | 0.1 | 0.1 | 0.1 | 0.1 | 0.1 | 0.1 | 0.1 |
| Lubricant [%] | — | — | — | — | — | 0.3 | 0.3 | 0.3 |
| GF [%] | 25 | 25 | 25 | 25 | 25 | 25 | 25 | 25 |
| Properties | | | | | | | | |
| UL 94 1.6 mm | V-0 | V-0 | V-0 | V-0 | V-0 | V-0 | V-0 | V-0 |
| UL 94 0.8 mm | V-0 | V-2 | V-0 | V-0 | V-0 | V-0 | V-0 | V-0 |
| MVR [cc/10 min] | 12 | 25 | 21 | 30 | 23 | 23 | 30 | 70 |
| Flow spiral [cm] | 16.8 | — | — | — | 21.5 | — | — | — |
| Injection molding | 2412 | 1834 | 1720 | 1753 | 1630 | — | — | — |
| pressure [bar] | | | | | | | | |
| Tensile strength | 103 | 97 | 99 | 102 | 100 | 104 | 102 | 95 |
| [MPa] | | | | | | | | |
| Tensile modulus | 10.1 | 9.3 | 9.6 | 9.6 | 9.2 | 10.3 | 9 | 8.5 |
| [GPa] | | | | | | | | |
| Notched impact test | 48.4 | 44.5 | 43.3 | 45.6 | 47.7 | 40.9 | 43.3 | 40.8 |
| [kJ/m²] | | | | | | | | |

Examples: Polyalkylene terephthalate polyether+DEPAL+MC

| | Comp. ex. | Inv. ex. 11 | Inv. ex. 12 | Inv. ex. 13 |
|---|---|---|---|---|
| Component | | | | |
| PBT 1 [%] | 52.4 | 47.4 | 42.4 | 47.4 |
| DEPAL [%] | 15 | 15 | 15 | 15 |
| MC [%] | 7.5 | 7.5 | 7.5 | 7.5 |
| Polyalkylene | — | 5 | 10 | |
| terephthalate | | | | |
| polyether 1 [%] | | | | |
| Polyalkylene | — | — | — | 5 |
| terephthalate | | | | |
| polyether 2 [%] | | | | |
| Stabilizer [%] | 0.1 | 0.1 | 0.1 | 0.1 |
| GF [%] | 25 | 25 | 25 | 25 |
| Properties | | | | |
| UL 94 1.6 mm | V-0 | V-0 | V-0 | V-0 |
| UL 94 0.8 mm | V-2 | V-0 | V-2 | V-2 |
| MVR [cc/10 min] | 20 | 23 | 30 | 33 |
| Tensile strength | 96 | 98 | 96 | 101 |
| [MPa] | | | | |
| Tensile modulus | 10.0 | 9.7 | 9.2 | 9.9 |
| [GPa] | | | | |
| Notched impact | 39.7 | 43.5 | 47 | 43 |
| test [kJ/m²] | | | | |

Examples: Polyalkylene terephthalate polyether+DEPAL+MC+MPP

| | Comp. ex. | Inv. ex. 14 | Inv. ex. 15 | Inv. ex. 16 | Reference c | Inv. ex. 17 | Inv. ex. 18 |
|---|---|---|---|---|---|---|---|
| Component | | | | | | | |
| PBT 1 [%] | 52.4 | 47.4 | 42.4 | 47.4 | — | — | — |
| PBT 2 [%] | — | — | — | — | 52.1 | 47.1 | 42.1 |
| DEPAL [%] | 15 | 15 | 15 | 15 | 15 | 15 | 15 |
| MC [%] | 3.75 | 3.75 | 3.75 | 3.75 | 3.75 | 3.75 | 3.75 |
| MPP [%] | 3.75 | 3.75 | 3.75 | 3.75 | 3.75 | 3.75 | 3.75 |
| Polyalkylene | — | 5 | 10 | — | — | 5 | 10 |
| terephthalate | | | | | | | |
| polyether 1 [%] | | | | | | | |
| Polyalkylene | — | — | — | 5 | — | — | — |
| terephthalate | | | | | | | |
| polyether 2 [%] | | | | | | | |
| Stabilizer [%] | 0.1 | 0.1 | 0.1 | 0.1 | 0.1 | 0.1 | 0.1 |
| Lubricant [%] | — | — | — | — | 0.3 | 0.3 | 0.3 |
| GF [%] | 25 | 25 | 25 | 25 | 25 | 25 | 25 |
| Properties | | | | | | | |
| UL 94 1.6 mm | V-0 | V-0 | V-0 | V-0 | V-0 | V-0 | V-0 |
| UL 94 0.8 mm | V-0 | V-0 | V-0 | V-0 | V-0 | V-0 | V-0 |
| MVR (cc/10 min) | 12 | 15 | 16 | 11 | 23 | 28 | 30 |
| Flow spiral (cm) | 16.8 | 17.9 | — | — | — | — | — |
| Injection molding | 2412 | 2213 | 1896 | 2294 | — | — | — |
| pressure (bar) | | | | | | | |
| Tensile strength | 103 | 98 | 96 | 101 | 104 | 100 | 98 |
| (MPa) | | | | | | | |
| Tensile modulus | 10.1 | 9.7 | 9.1 | 10.0 | 10.3 | 9.8 | 9.4 |
| (GPa) | | | | | | | |
| Notched impact | 48.4 | 46.4 | 47.9 | 47 | 40.9 | 45.1 | 45.5 |
| test (kJ/m²) | | | | | | | |

Examples: Polyalkylene terephthalate polyester+DEPAL+MC+MPP

| | Comp. ex. | Inv. ex. 19 | Inv. ex. 20 |
|---|---|---|---|
| Component | | | |
| PBT 2 [%] | 52.1 | 47.1 | 42.1 |
| DEPAL [%] | 15 | 15 | 15 |
| MC [%] | 3.75 | 3.75 | 3.75 |
| MPP [%] | 3.75 | 3.75 | 3.75 |
| Polyalkylene terephthalate | — | 5 | 10 |
| polyester [%] | | | |
| Stabilizer [%] | 0.1 | 0.1 | 0.1 |
| Lubricant [%] | 0.3 | 0.3 | 0.3 |
| GF [%] | 25 | 25 | 25 |
| Properties | | | |
| UL 94 1.6 mm | V-0 | V-0 | V-0 |
| UL 94 0.8 mm | V-0 | V-0 | V-0 |
| MVR (cc/10 min) | 23 | 44 | 52 |
| Flow spiral (cm) | — | — | — |
| Injection molding pressure | — | — | — |
| (bar) | | | |
| Tensile strength (MPa) | 104 | 95 | 95 |
| Tensile modulus (GPa) | 10.3 | 8.6 | 8.8 |
| Notched impact test (kJ/m²) | 40.9 | 44.7 | 45 |

In comparison with the comparative example, the specimens exhibited improved mechanical properties with improved flame-retardant effect (comparative example and inter alia inventive example 2).

The addition of melamine polyphosphate further improves the flame-retardant effect (inventive example 3 and inter alia inventive example 7). Furthermore, the compounds exhibited improved mechanical properties in comparison with the comparative example, and in particular in the impact test the thermoplastic compositions exhibited improved Charpy impact resistance (comparative example and inter alia inventive example 9).

In another embodiment, mixtures were produced comprising PBT, aluminum diethylphosphinate (DEPAL), melamine cyanurate, respectively polyalkylene terephthalate polyether 1 or polyalkylene terephthalate polyether 2, and also the stabilizer Irganox 1010 from BASF, and PPG 3786 glass fibers. The quantitative proportions of polyalkylene terephthalate polyether 1 and, respectively, polyalkylene terephthalate polyether 2 were varied.

In comparison with the comparative example, the specimens exhibited improved mechanical properties with improved flame-retardant effect (comparative example and inter alia inventive example 11).

In another embodiment, melamine polyphosphate was added to this mixture, and this further improved the flame-retardant effect (inventive example 12 and inter alia inventive example 15). Furthermore, the compounds exhibited improved mechanical properties in comparison with the comparative example, and in particular in the impact test the thermoplastic compositions exhibited improved Charpy impact resistance (comparative example and inter alia inventive examples 17 and 18).

In another embodiment, mixtures were produced comprising PBT, aluminum diethylphosphinate (DEPAL), melamine cyanurate, melamine polyphosphate, and a polyalkylene terephthalate polyester (poly(butylene terephthalate), poly(butylene adipate)), and also the stabilizer Irganox 1010 from BASF, and PPG 3786 glass fibers. The quantitative proportions of polyalkylene terephthalate polyester were varied.

In comparison with the comparative example, the specimens exhibited improved mechanical properties with improved flame-retardant effect (comparative example and inter alia inventive examples 19 and 20).

In all of the inventive examples, in comparison with the comparative examples, flowability values were improved by the addition of polyalkylene terephthalate polyester urethane 1, 2, 3, polyalkylene terephthalate polyether 1, 2, and polyalkylene terephthalate polyester.

1-10. (canceled)

11. A thermoplastic composition comprising
A) a polyalkylene terephthalate
B) an elastomer selected from the group consisting of
b1) polyalkylene terephthalate polyester urethanes,
b2) polyalkylene terephthalate polyether urethanes,
b3) polyalkylene terephthalate polyethers,
b4) polyalkylene terephthalate polyesters,
and mixtures of these,
C) a halogen-free flame retardant selected from the group consisting of
c1) nitrogen-containing flame retardants,
c2) nitrogen- and phosphorus-containing flame retardants,
c3) phosphorus-containing flame retardants selected from the group consisting of phosphates, phosphinic salts, diphosphinic salts, and mixtures of these,
and mixtures of these,
wherein the proportions by weight of C) are from 5 to 35% by weight, based on the entire thermoplastic composition.

12. The thermoplastic composition of claim 11, wherein b1) is a polybutylene terephthalate polyester urethane.

13. The thermoplastic composition of claim 11, wherein c1) is a nitrogen-containing heterocycle having at least one nitrogen atom.

14. The thermoplastic composition of claim 11 which further comprises D) a reinforcing addition.

15. The thermoplastic composition of claim 11, comprising (A) a polybutylene terephthalate, (B) a polybutylene terephthalate polyester urethane (b1), (C) aluminum diethylphosphinate, melamine cyanurate, or melamine polyphosphate, or a mixture of these.

16. The thermoplastic composition of claim 11, comprising (A) a polybutylene terephthalate, (B) a polybutylene terephthalate polyether (b3), (C) aluminum diethylphosphinate, melamine cyanurate, or melamine polyphosphate, or a mixture of these.

17. The thermoplastic composition of claim 11, comprising (A) a polybutylene terephthalate, (B) a polybutylene terephthalate polyester (b4), (C) aluminum diethylphosphinate, melamine cyanurate, or melamine polyphosphate, or a mixture of these.

18. A method of preparing a coating composition utilizing the thermoplastic composition of claim 11.

19. A method of producing fibers, foils, or moldings utilizing the thermoplastic composition of claim 11.

20. A fiber, foil, or molding comprising the thermoplastic composition of claim 11.

21. A coating composition comprising the thermoplastic composition of claim 11.
